(19) United States
(12) Patent Application Publication
(10) Pub. No.: US 2005/0186316 A1
(43) Pub. Date: Aug. 25, 2005

(54) Fried bakery products with low oil absorption and process for preparation thereof

(76) Inventors: Masaki Maruyama, Aichi-ken (JP); Masayo Ebihara, Tokyo (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/886,277

(22) Filed: Jul. 6, 2004

(30) Foreign Application Priority Data
Feb. 20, 2004 (JP) 2004-045381

(51) Int. Cl. A21D 10/00

(52) U.S. Cl. 426/549

(57) ABSTRACT

The present invention relates to fried bakery products which are not clammy and wet, have adequate crispness, do not cause heartburn, have a good chewy feel and are palatable, providing healthy feelings. The fried bakery products are obtained by preparing a dough from the starting materials for the dough with mixing and kneading them; subjecting the dough to preliminary fermenting and to dividing and molding, and fermenting the molded products; partial-baking the fermented molded products in order not to be scorched on the surfaces; and frying the partial-baked products in oil, and they have a lower oil absorption compared with those fried bakery products obtained by frying the fermented molded products without partial-baking, are not clammy and have adequate crispness.

### BACKGROUND OF THE INVENTION

1. Field of the Invention

The present invention relates to fried bakery products with low oil absorption and a process for preparation thereof, and more specifically, to fried bakery products which are not greasy and not clammy, have adequate crispness, have a good chewy feel and are palatable, providing healthy feelings, and a process for preparation thereof.

2. Description of the Related Art

Previously, a mix powder for oil processed foods such as doughnuts was proposed, whose grains have a particle size of 500 μm or less, and which contain stearic acid and/or behenic acid as the main constituent fatty acid, and polyglycerin fatty acid esters with a degree of esterification of 50% or more (refer to the Patent Document 1).

Further, a process for preparing fried bakery products with fillings was proposed, wherein during the preparation of fried bakery products having fillings inside, such as doughnuts, by means of the fermentation with yeasts, the fillings are prevented from running out upon breakage of the bakery products when fried in oil, by treating the surface of the bakery products with warm water at 35 to 60° C. after molding the bakery products, and then frying them in oil (refer to the Patent Document 2).

[Patent Document 1]

Japanese Unexamined Patent Application Publication No. 2003-333993

[Patent Document 2]

Japanese Unexamined Patent Application Publication No. 2003-189785

However, the conventional doughnuts have problems such as having greasy odors and lessened flavor, being clammy and wet, giving a poor chewy feel or melting feel in the mouth, and providing unhealthy feelings, such as heartburn or the like, because the oil absorption increases as the absorption of oil advances when the doughnuts are fried in oil; and in addition to these, they also have problems such as that they are not voluminous and not soft, have a short best-before period of 1 to 2 day(s) owing to their susceptibility to aging, and that having a high oil absorption, they stick to the package materials or cause the icing of granulate sugar or chocolate to melt, with the lower parts of the products usually not swelling sufficiently, and that the frying oil is easily contaminated and also quickly decreases in amount during the frying process.

### SUMMARY OF THE INVENTION

The first object of the present invention is to provide, by solving the problems described above, fried bakery products which by the decrease in oil absorption, do not have greasy odors, have good flavor, are not clammy, have a good chewy feel and melting feel in the mouth and do not cause heartburn; which are voluminous, soft, have a long best-before period of, for example, about 1 week since they are not susceptible to aging, do not stick to the packaging materials, and do not cause the icing of granulate sugar or chocolate to melt easily; and which uniformly swell, and are adequately crispy and palatable, providing healthy feelings.

The second object of the present invention is to provide a process for preparing such fried bakery products with low oil absorption, wherein the bakery products are easily prepared without significantly contaminating the frying oil and decreasing the amount of oil during the frying process.

The fried bakery products with low oil absorption claimed in claim 1 of the present invention are characterized in that they are obtained by preparing a dough from the starting materials for the dough with mixing and kneading them, subjecting the dough to preliminary fermenting and to dividing and molding, fermenting the molded products, partial-baking the fermented molded products in order not to be scorched on the surfaces, and frying the partial-baked products in oil, and are characterized in that they have a lower oil absorption compared with the fried bakery products obtained by frying the fermented molded products without partial-baking, are not clammy and have adequate crispness.

The fried bakery products claimed in claim 2 of the present invention are characterized in that a natural yeast is used for the fried bakery products according to claim 1.

The fried bakery products claimed in claim 3 of the present invention are characterized in that the fried bakery products according to claim 1 or 2 are filled with fillings.

Claim 4 of the present invention is a process for preparing fried bakery products, characterized in comprising the steps (1) to (5) of

(1) preparing a dough by mixing and kneading the starting materials for the dough;

(2) subjecting thus obtained dough to preliminary fermenting and to dividing and molding, and fermenting the dough to obtain fermented molded products;

(3) partial-baking the fermented molded products to obtain partial-baked products having no scorched marks on the surfaces;

(4) frying the partial-baked products to obtain fried bakery products with low oil absorption, which have a lower oil absorption compared with the fried bakery products obtained by frying the fermented molded products without partial-baking, and which are not clammy and have adequate crispness; and

(5) if desired, filling the fried bakery products with filling.

Claim 5 of the present invention describes the process for preparing fried bakery products according to claim 4 which is characterized in that the fermented molded products are partial-baked at a temperature of 130 to 200° C. for 7 to 25 minutes.

Claim 6 of the present invention describes the process for preparing fried bakery products according to claim 4 or 5 which is characterized in that when the partial-baked products are fried, the products are fried on one side at 170 to 190° C. for 60 to 150 seconds, and then reversed and fried again on the other side at 170 to 190° C. for 60 to 150 seconds in the reversing mode; and the products are fried as a whole at 170 to 190° C. for 60 to 150 seconds in the submerging mode.

The fried bakery products with low oil absorption claimed in claim 1 of the present invention are fried bakery products that are obtained by preparing a dough from the starting materials for the dough with mixing and kneading them, subjecting the dough to preliminary fermenting and to dividing and molding, fermenting the molded products, partial-baking the fermented molded products in order not to be scorched on the surfaces, and frying the partial-baked products in oil, and they provide marked effects such as that they have a lower oil absorption compared with those fried bakery products obtained by frying the fermented molded products without partial-baking, they are not clammy and have adequate crispness; that they do not have greasy odors, have good flavor, are not wet, have a good chewy feel and melting feel in the mouth and do not cause heartburn; that they are voluminous and soft, have a long best-before period of, for example, about 1 week since they are not susceptible to aging, and do not stick to the packaging materials, and do not cause the icing of granulate sugar or chocolate to melt easily; and that they swell uniformly and are crispy and palatable, providing healthy feelings.

The fried bakery products claimed in claim 2 of the present invention are the fried bakery products described in claim 1, wherein because a natural yeast is used in the fermentation, the fermenting activity is maintained even if the fermenting and aging processes take long time of, for example, 4 hours to 2 days. Thus, such long fermenting and aging result in more significant effects such as that they become richer in flavor and taste, softness is imparted, and that the taste, eating quality and eating texture of the fried bakery products are improved.

The fried bakery products claimed in claim 3 of the present invention are the fried bakery products described in claim 1 or 2, wherein they are filled with fillings, and therefore they present marked effects of providing fried bakery products that are rendered with the eating quality and eating texture of fillings including curry, bean jam, cream, meat and the like, such as curry buns, twisted doughnuts, bean jam doughnuts, cream doughnuts, fried buns, Danish doughnuts, piroshkis and the like.

Claim 4 of the present invention relates to a process for preparing fried bakery products, wherein it comprises the above mentioned steps of (1) to (5), and gives marked effects such as that upon frying the fried bakery products of the present invention, the fried bakery products are prepared easily without the frying oil being much contaminated or significantly decreasing in amount.

Claim 5 of the present invention relates to the process for preparing fried bakery products according to claim 4, which gives even more remarkable effects such as that because the fermented molded products are partial-baked at 130 to 200° C. for 7 to 25 minutes, no scorched marks are produced on the surface of the bakery products, and the flavor and taste do not escape, thus allowing easy preparation of partial-baked products with an adequate moisture content, which are suitable for the preparation of fried bakery products with low oil absorption of the present invention.

Claim 6 of the present invention relates to the process for preparation of fried bakery products according to claim 4 or 5, wherein when the partial-baked products are fried, the products are fried on one side at 170 to 190° C. for 60 to 150 minutes, and then reversed and fried again on the other side at 170 to 190° C. for 60 to 150 minutes in the reversing mode; and the products are fried as a whole at 170 to 190° C. for 60 to 150 minutes in the submerging mode. The process presents marked effects such as that the frying oil is not much contaminated or decreased in amount, and that it allows preparation of the fried bakery products of the present invention which have a lower oil absorption compared with the fried bakery products obtained by frying the fermented molded products without partial-baking, and which are not clammy and have adequate crispness.

### BRIEF DESCRIPTION OF THE DRAWINGS

FIG. 1 is a schematic illustration of an embodiment of the preparation process for the fried bakery products of the present invention.

FIG. 2 is a schematic illustration of the traditional preparation process for fried bakery products.

FIG. 3 is a graph exhibiting the relationship between the oil absorption (g) and the number of days of storage for ring doughnuts.

FIG. 4 is a graph exhibiting the relationship between the oil absorption (g) and the number of days of storage for bean jam doughnuts.

### DESCRIPTION OF THE PREFERRED EMBODIMENT

Hereinafter, the embodiments of the present invention are described in detail.

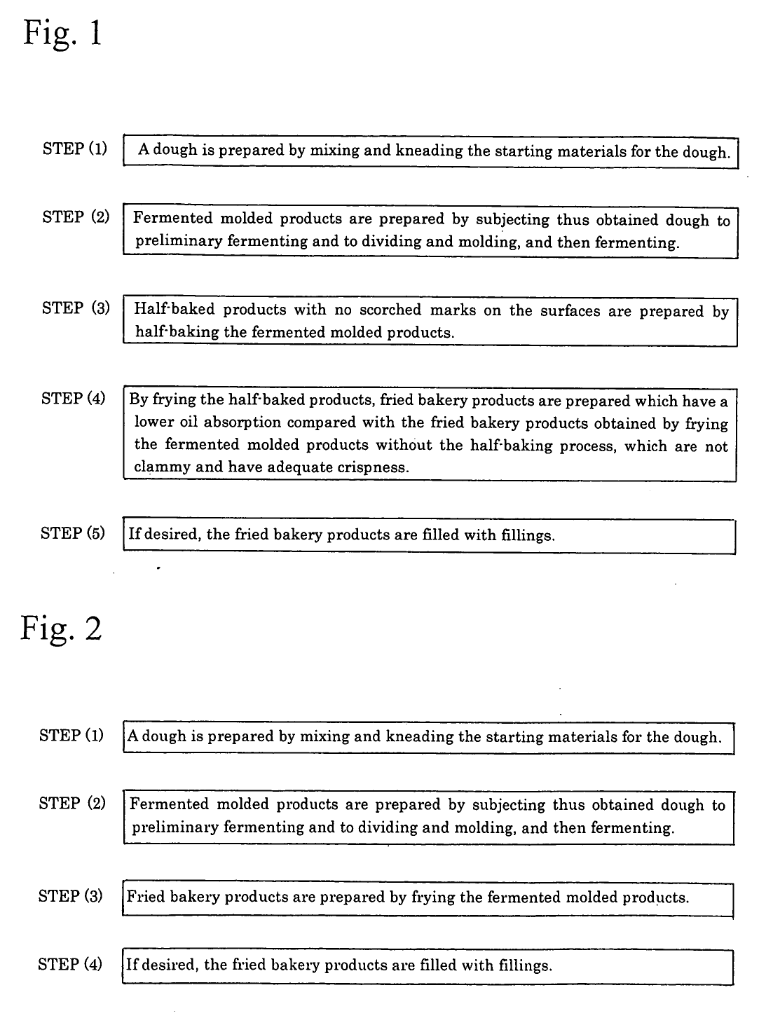

FIG. 1 (1) to (5) is a schematic illustration of an embodiment of the preparation process for the fried bakery products with low oil absorption according to the present invention.

FIG. 2 is a schematic illustration of the conventional preparation process for fried bakery products.

In FIG. 1, in order to produce the fried bakery products with low oil absorption of the present invention, a dough is first prepared by mixing and kneading the starting materials for the dough in Step (1).

The starting materials for the dough of the present invention include the substrates for the fermentation (for example, wheat flour, cereals such as rye and rice, potatoes and sweet potatoes, fruits such as apples, grapes, and the like), fats and oils, sugar, yeast, lactic acid bacteria for Italian cakes [Lactobacillus] (L. comoensis, deposited at the Institute of Industrial Technologies for Microorganisms, Depository No. 9022)], fermenting strains such as Saccaromyces exiguus, Lactobacillus sanfrancisco, Lactobacillus acidifarinarius (Depository No. FERMP-18577), maltose, table salt, emulsifying agents, thickening polysaccharides, flavors, and the like.

In the present invention, it is preferred to use a natural yeast which has not been much used traditionally. While an industrial yeast has an activity duration of about 4 hours, a natural yeast retains the same duration in the order of 4 hours to 2 days or longer. A natural yeast, when used in the fermenting and aging processes of an extended time period, enriches the flavor and taste to a greater degree and produces soft and palatable fried bakery products, and hence is preferably used.

It is also possible to use the substrates for the fermentation in which wheat flour is blended with suitable amounts of rye flour, rice flour or the like. The type of the substrates for the fermentation is not particularly limited. Wheat flour may be exemplified by, for example, cake flour, all-purpose flour or bread flour, but in the aspect of the mechanical resistance of the dough, it is preferable to use bread flour or all-purpose flour of high viscosity type.

For the fats and oils used in the present invention, for example, shortening, margarine, butter, lard and the like are used in combination.

For the sugars used in the present invention, various types of starch (corn starch, wheat starch, potato starch, etc.), sugar, reduced sugar, Trehalose (tradename; manufactured by Hayashibara Co., Ltd.) and the like may be used in combination, but it is preferred to use the combination of wheat starch and Trehalose in terms of taste and sweetness.

A dough for doughnuts and the like is prepared by mixing and kneading, for example, grain flour such as wheat flour, fats and oils, sugar, table salt, fermenting strains, or a pre-mix thereof, with egg, natural yeasts, yeast and water. It is also possible to use a mixer in the mixing and kneading processes. During the mixing, it is possible to add appropriate amounts of the pastes or powders of cheese, vegetables or the like, tofu, soy milk, bean curd residue, Matcha, cocoa and the like, and thus the dough can have a wide variety of flavors. The temperature for kneading is not particularly limited, but the kneading process is preferably carried out at about 26° C. to about 35° C.

Further, in Step (2), thus obtained dough is subjected to preliminary fermenting and dividing and molding, and then is fermented to yield fermented molded products.

For example, during the floor time, preliminary fermenting of the dough for doughnuts or the like is carried out (at about 38° C. to about 40° C., for 4 hours or more to 2 days) to result in the swelling of the dough to about 2-folds to about 2.5-folds the volume. By such flooring, any dough damaged by the mixing and kneading processes can be restored to the original state.

Subsequently, dividing and molding of the dough are carried out. A dough obtained after the completion of kneading is divided into suitable sizes and molded. Dividing may be carried out to produce bakery products of appropriate sizes for doughnuts or the like. For instance, the dough is divided into lumps of about 45 g to about 80 g, although the size may vary depending on the type of fillings. After the dividing process, bench time may be carried out according to those processes known in the art. Molding of the dough for doughnuts or the like, such as rounding, may be carried out to yield, for example, buns, rings and so forth.

Next, fermenting is carried out to produce fermented molded products. Molded lumps of dough are arranged on baking sheets or screens and are fermented. The temperature for fermenting is not particularly limited but is preferably set at 25° C. to 42° C. The humidity for fermenting is not particularly limited but is preferably set at about 50% to about 70%. The time for fermenting is not particularly limited, but it is preferred to carry out fermenting for about 1 hour or more to about 12 hours.

In step (3), the fermented molded products are partial-baked to produce partial-baked products which have no scorched marks on the surfaces, retain an appropriate moisture content, and hold the main components of the flavor and taste from escaping. The conditions such as temperature or time of partial-baking the fermented molded products obtained after the completion of fermenting are not particularly limited, but it is important to use the baking conditions that ensure no formation of scorched marks on the surfaces of the products.

It is preferred to partial-bake the fermented molded products at 130 to 200° C. for 7 to 25 minutes, since these conditions ensure the facilitated production of partial-baked products which have no scorched marks on the surfaces, retain an appropriate moisture content (for example, about 20 to 30% by mass immediately after baking), and hold the main components of the flavor from escaping. For instance, the fermented molded products after the completion of fermenting are conventionally baked at 220 to 230° C. for 5 to 20 minutes to produce bakery products. However, under these conditions, scorched marks appear on the surfaces of the bakery products.

Under the conditions of 130° C. and less than 7 minutes of duration, although scorched marks do not appear on the surface, baking is insufficient, and the residual moisture content excessively exceeds the appropriate moisture content, and thus after frying, it is not likely to obtain fried bakery products with adequate crispness. On the other hand, under the conditions of 200° C. and more than 25 minutes of duration, the residual moisture content becomes much less than the appropriate moisture content (for example, less than about 20% by mass immediately after baking), and as a result, it is not likely to obtain fried bakery products with low oil absorption. Moreover, it is likely to have scorched marks on the surface, and when such scorched marks appear, it is not likely to obtain fried bakery products which have a good chewy feel and are palatable.

Further, in Step (4), the partial-baked products are fried to produce the fried bakery products with low oil absorption of the present invention which have a lower oil absorption compared with those fried bakery products obtained by frying the fermented molded products without partial-baking, which are not clammy and have adequate crispness. Before frying, if necessary, the bakery products may be coated on the surface with breaders such as breadcrumb, cracker crumb, or the like.

The shapes of the fried bakery products with low oil absorption of the present invention are not particularly limited, but specific examples of shapes may include the types of twist, ring, roll, and the like.

Fried bakery products are produced as the moisture contained in the partial-baked products is replaced by oil during frying. In the present invention, it is possible to obtain fried bakery products that have low oil absorption, are not clammy and have adequate crispness, as described above, by frying partial-baked products, and the reason for such possibility is believed to be that since partial-baking of fermented molded products brings about the reduction and adequate adjustment of the moisture content in the products, and also causes the surface of the products to attain appropriate viscosity, not all or most of the moisture contained in the partial-baked products, but only a portion of the moisture contained in the partial-baked products is replaced by oil. Of course, the hypothesis is not limited by this idea.

The term oil absorption of fried bakery products in the present invention denotes the total amount of oil absorbed by or adsorbed onto the bakery products during frying. The fried bakery products of the present invention have an oil absorption reduced by approximately 30 to 40% or more, compared with that of those fried bakery products obtained by direct frying of fermented molded products without partial-baking, and thus become not clammy but adequately crispy and palatable.

In one specific embodiment, the oil absorption of the fried bakery products obtained by frying the fermented molded products in the reversing mode, without partial-baking, at an oil temperature of 170° C. for 120 seconds was 28% by mass, as expressed in the percentage of absorbed oil, and the oil absorption of the fried bakery products obtained by frying the fermented molded products in the reversing mode, without partial-baking, at an oil temperature of 185° C. for 100 seconds was 22% by mass, while the oil absorption of the fried bakery products obtained by partial-baking the fermented molded products at 160° C. for 10 minutes and frying the partial-baked products with no scorched marks in the reversing mode at an oil temperature of 185° C. for 100 seconds was 15% by mass, as expressed the percentage of absorbed oil.

Herein, the percentage of absorbed oil (% by mass) is calculated from the following equation:
Percentage of absorbed oil (% by mass)=[A/B]×100
wherein A represents the oil absorption during frying (g), and B represents the weight of the whole fried bakery products obtained by frying.

The frying operation can be carried out by any conventional means of frying in oil. The type of oil or the apparatus for frying is not particularly limited.

The oil temperature is not particularly limited, but it is preferably set to 170° C. to 190° C., and more preferably to about 180° C. to about 185° C.

The frying mode can be exemplified by the reversing mode or the submerging mode, without being intended to be limited by these. The duration of frying may vary depending on the weight or state of the dough, or the frying mode; however, in the reversing mode, frying is preferably carried out for about 60 to 150 seconds for one side and then about 60 to 150 seconds for the other side, and in the submerging mode, frying is preferably carried out for about 60 to 150 seconds as a whole.

If frying is carried out at a temperature lower than 170° C. for less than 60 seconds, frying may be insufficient to produce fried bakery products that are not clammy and have adequate crispness; on the other hand, if frying is carried out at a temperature higher than 190° C. for more than 150 seconds, fried bakery products may burn black or have a poor chewy feel, and palatable fried bakery products may not be obtained.

Further, in Step (5) of the process of the present invention, bakery products can be filled with fillings, if desired.

Fillings denote the stuffing filled inside bakery products such as doughnuts, and fried bakery products may be filled with, for example, plain curry and flavored curry such as mushroom curry in curry doughnuts; bean paste with grains, filtered bean paste, bean paste with green tea powder, cherry taste paste, bean paste with chestnut, chocolate mixed paste, coffee mixed paste, milk mixed paste, strawberry mixed paste, banana mixed paste, melon mixed paste; milk cream, custard cream, chocolate custard cream, chocolate cream, coffee cream, yogurt cream, caramel cream, strawberry cream, melon cream, cheese cream, ice cream, sherbet, yogurt or the like in cream doughnuts; and stir-fried minced meat in meat doughnuts. Other fillings may include tuna, sausage, cheese, egg, jam, sweet potato, banana, apple and the like, but are not limited to these. The injection process for filling fried bakery products with fillings can be generally carried out by any conventional methods.

The description above illustrates only some examples of the process of the present invention, and thus it is possible to carry out various modifications of the present invention.

For example, the description above illustrates one of examples of filling the fried bakery products of the present invention with fillings as desired in Step (5); however, it is also possible to carry out filling of the partial-baked products after the partial-baking step and then frying in Step (3).

Also, in Step (3), the partial-baked products obtained after the partial-baking step may be used as they are, or as refrigerated or frozen products.

If refrigerated or frozen, freshness of the products can be maintained for an extended time period.

Moreover, it is also possible to commercialize those refrigerated or frozen products. Purchasers of the products may obtain fried bakery products with low oil absorption by frying the products themselves.

Further, in Step (3), the partial-baked products obtained after the partial-baking step may be filled with fillings, and then used as they are, or as refrigerated or frozen products.

If refrigerated or frozen, freshness of the products can be maintained for an extended time period.

Moreover, it is also possible to commercialize those refrigerated or frozen products. Purchasers of the products may obtain fried bakery products with low oil absorption by frying the products themselves.

Also, in Step (3), it is also possible to batter the surface of the partial-baked products obtained after the partial-baking step with water, followed by coating the surface with breaders such as breadcrumb or cracker crumb, and to use the products as they are, or as refrigerated or frozen products. It is also possible to fill the above products with fillings and to use the resulting products as they are, or as refrigerated or frozen products. It is also possible to commercialize these products.

If refrigerated or frozen, freshness of the products can be maintained for an extended time period.

As mentioned in the above, purchasers of the products may obtain fried bakery products with low oil absorption by frying the products themselves.

The preparing process of the present invention may be carried out either manually, or completely automatically using machines, since many steps can be carried out mechanically, and it is also possible to carry out manually and mechanically in combination. Since the operation is simple, the fried bakery products according to the present invention can be readily produced with high efficiency and uniform quality, without requiring any special skills.

According to the process for preparing conventional fried bakery products as depicted in FIG. 2, since fried bakery products are produced by directly frying (for example, by the reversing mode, at about 180° C., for 240 seconds) the fermented molded products obtained after the fermenting step, without partial-baking the fermented molded products obtained by the same method as the present invention, thus obtained fried bakery products have an oil absorption higher than that of the fried bakery products of the present invention, thus having greasy odors, lessened flavor and taste, wetness and clamminess, an unpleasant chewy feel or melting feel in the mouth, and lacking the healthy feelings, for example heartburn or the like. In addition to that, the traditional fried bakery products have such problems that they are not voluminous and not soft, and have a short best-before period of 1 to 2 day(s) owing to their susceptibility to aging; that having absorbed a large amount of oil, they stick to the package materials or cause the icing of granulate sugar or chocolate to melt, with the lower parts of the products usually not sufficiently swelling; and that the frying oil is easily contaminated and also quickly decreases in amount during the frying process.

Next, the present invention will be explained in more detail by the following examples and comparative examples, but it is not intended to be limited by them.

### EXAMPLE 1

A dough of the following composition (parts by mass) was produced by mixing and kneading the following starting materials for dough.

(Composition)

| | |
|---|---|
| Wheat flour (including a natural yeast) | 100 |
| Fats and oils | 30 |
| Eggs | 15 |
| Sugar | 30 |
| Water | 47 |
| Emulsifying agent | 1.2 |
| Table salt | 1.2 |
| Powdered milk | 3 |
| Malt | 0.25 |
| Yeast | 0.5 |

In preparing a dough, supplementary materials (sugar, eggs, table salt, malt, fats and oils, powdered milk, etc.) were emulsified, and wheat flour and water were added to natural yeast species to carry out low-temperature fermenting of the dough at 15 to 20° C. for 24 to 36 hours. This dough was again added with wheat flour and water and fermented at 24 to 28° C. for 4 to 12 hours. To the natural yeast species, yeasts and emulsified additional materials were added, and mixing was performed.

Further, thus obtained dough was divided and molded into the buns (about 50 g), and then was fermented (about 1 hour to 12 hours) to produce fermented molded products.

The fermented molded products were partial-baked at 130 to 160° C. for 7 to 8 minutes to produce partial-baked products which have no scorched marks on the surfaces, retain an appropriate moisture content (in the order of about 22 to 28% by mass), and hold the main components of flavor from escaping.

The partial-baked products were fried in the reversing mode, on one side at an oil temperature of 185° C. for 100 seconds, and on the other side under the same conditions, to easily obtain the fried bakery products of the present invention, without significantly contaminating the frying oil or decreasing the amount of the frying oil.

The oil absorption of the fried bakery products of the present invention was 15% by mass, as expressed in the percentage of absorbed oil. As a result of a tasting evaluation by 30 panelists, the fried bakery products were evaluated to be palatable fried bakery products that were not clammy or wet, had adequate crispness, had no greasy odor, had good flavor, had a good chewy feel and melting feel in the mouth, did not cause heartburn, and that were voluminous and soft, uniformly swelled and had good eating quality and eating texture, providing healthy feelings.

The fried bakery products of the present invention were not easily aged such that the best-before period was about one week long, they did not stick to the packaging materials when packaged, and the icing of granulate sugar or chocolate did not melt.

### COMPARATIVE EXAMPLE 1

Fried bakery products were obtained by frying the fermented molded products obtained in Example 1, without partial-baking them, on one side at an oil temperature of 185° C. for 120 seconds, and on the other side under the same conditions, and the oil absorption of the fried bakery products were 22% by mass as expressed in the percentage of absorbed oil.

As a result of evaluating thus obtained fried bakery products by the same process, they were evaluated to be unpalatable owing to their high oil absorption and greasiness, felt like eating grease, had greasy odors and bad eating texture, with the surfaces shining with grease.

The resulting fried bakery products were susceptible to aging and had a short best-before period of 1 to 2 day(s), tended to stick to the packaging materials when packaged, and the icing on the surface tended to melt.

### EXAMPLES 2 TO 10

A dough of the same composition as that of Example 1 was prepared, preliminarily fermented, subjected to dividing and molding into suitable shapes (rings or buns) (about 50 g), and then fermented to produce fermented molded products.

Further, these fermented molded products were partial-baked under the conditions of the baking temperature/baking time as presented in Table 1 below, to produce partial-baked products with no scorched marks on the surfaces, and these fried bakery products were fried in the reversing mode at the oil temperature and frying time as represented by Table 1, to obtain the fried bakery products of the present invention, without significantly contaminating the frying oil or decreasing the amount of the frying oil.

Table 1 summarizes the shape resulting from the dividing and molding processes, mass before frying (g), mass after frying (g), the oil absorption (g) and the percentage of absorbed oil (%), as well as the results of the tasting evaluation carried out according to the following criteria, and the best-before period evaluated according to the following criteria.

In Table 1, the frying time (seconds) is described to be 70-70, and this indicates frying on one side for 70 seconds, reversing and frying on the other side for 70 seconds.

(Evaluation Criteria)

(1) Results of tasting: As a result of a tasting evaluation carried out by 30 panelists by the same method as in Example 1, palatable fried bakery products that are not clammy or wet and adequately crispy, do not have greasy odors, have good flavor, have a good chewy feel and melting feel in the mouth, do not cause heartburn, and that are voluminous and soft, have good eating quality and eating texture, and provide healthy feelings, are rated ⊚, those with lessened qualities are rated Δ, and those with poor qualities are rated x.

(2) Best-before period: Those fried bakery products which do not readily age and have a best-before period of 1 week or longer are rated ⊚, and those which readily age and have a short best-period of 1 to 2 day(s) are rated Δ.

### COMPARATIVE EXAMPLES 2 TO 5

Fried bakery products for comparison were obtained by frying the fermented molded products obtained from Example 1, without partial-baking them, at the oil temperature and frying time as indicated in Table 2 in the reversing mode.

Table 2 summarizes the shape resulting from the dividing and molding processes, mass before frying (g), mass after frying (g), the oil absorption (g) and the percentage of absorbed oil (% by mass), as well as the results of the tasting evaluation by the same method as in the Examples and the best-before periods.

TABLE 1

| | Example | | | | | | | | |
|---|---|---|---|---|---|---|---|---|---|
| | 2 | 3 | 4 | 5 | 6 | 7 | 8 | 9 | 10 |
| Shape resulting from | ring | → | → | → | → | → | Bun | → | → |
| the dividing and | | | | | | | | | |
| shaping processes | | | | | | | | | |
| Baking temp. (° C.) | 130 | → | 160 | → | → | → | → | → | → |
| Baking time (min) | 20 | → | 7 | → | → | → | → | → | → |
| Oil temp. (° C.) | 185 | → | → | → | → | → | → | → | → |
| Frying time (sec) | 70—70 | → | → | → | → | → | → | → | → |
| Mass before frying (g) | 45 | 45 | 40.8 | 47 | 49 | 45 | 24 | 23 | 24 |
| Mass after frying (g) | 52.9 | 54 | 48 | 54 | 60 | 54 | 28 | 27 | 27 |
| Amount of oil absorbed (g) | 7.9 | 9 | 7.2 | 7 | 11 | 9 | 4 | 4 | 3 |
| Percentage of absorbed | 14.9 | 17 | 15 | 13 | 18 | 16 | 14 | 15 | 11 |
| oil (% by mass) | | | | | | | | | |
| Tasting evaluation | ⊚ | ⊚ | ⊚ | ⊚ | ⊚ | ⊚ | ⊚ | ⊚ | ⊚ |
| Best-before period | ⊚ | ⊚ | ⊚ | ⊚ | ⊚ | ⊚ | ⊚ | ⊚ | ⊚ |

TABLE 2

Comparative
Example

| | 2 | 3 | 4 | 5 |
|---|---|---|---|---|
| Shape | Ring | → | → | → |
| resulting | | | | |
| from the | | | | |
| dividing | | | | |
| and shaping | | | | |
| processes | | | | |
| Oil temp. | 185 | → | → | → |
| (° C.) | | | | |
| Frying time | 70—70 | → | 90—90-30 | → |
| (sec) | | | | |
| Mass before | 47.6 | 49 | 47.8 | 51 |
| frying (g) | | | | |
| Mass after | 61.9 | 64 | 65.3 | 69 |
| frying (g) | | | | |
| Amount of | 14.3 | 15 | 17.5 | 18 |
| oil | | | | |
| absorbed | | | | |
| (g) | | | | |
| Percentage | 23.1 | 23 | 26.8 | 26 |
| of absorbed | | | | |
| oil (% by | | | | |
| mass) | | | | |
| Tasting | Δ | Δ | Δ | Δ |
| evaluation | | | | |
| Best-before | Δ | Δ | Δ | Δ |
| period | | | | |

Since the fried bakery products of the present invention of Examples 2 to 10 had low oil absorption, they were palatable fried bakery products rated ⊚ from the tasting evaluation, which swelled uniformly, had good eating quality and eating texture and provided healthy feelings.

The fried bakery products of the present invention of Examples 2 to 10 did not age readily, thus having the best-before periods rated ⊚, and did not stick to the packaging materials when packaged, and the icing of granulate sugar or chocolate did not melt.

To the contrary, the fried bakery products of Comparative Examples 2 to 5 had high oil absorption, and thus they were rated Δ from the tasting evaluation and were evaluated to be greasy and unpalatable, felt like eating grease, had greasy odors and bad eating texture with the surfaces shining with greases.

The fried bakery products of Comparative Examples 2 to 5 readily aged, thus having the best-before periods rated Δ, and had a tendency to stick to the packaging materials when packaged, and the icing of granulate sugar or chocolate tended to melt.

### EXAMPLE 11

The fried bakery products of the present invention were obtained by preparing fermented molded products (ring doughnuts and bean jam doughnuts (sweetened bean jam)) by the same method as in Examples 2 to 10, preparing partial-baked products with no scorched marks on the surfaces by partial-baking the fermented molded products at 130° C. for 20 minutes, and frying the partial-baked products on the very day of preparation at an oil temperature of 185° C. and frying time of 70-70 (seconds) in the reversing mode; at the same time, the fried bakery products of the present invention were obtained by frying the partial-baked products after having refrigerated at 5° C. for 1 to 8 day(s), respectively at an oil temperature of 185° C. and frying time of 70-70 (seconds) in the reversing mode. The bean jam doughnuts were prepared by filling the fermented molded products with about 25 to 30 g of the bean jam filling and then partial-baking under the above-mentioned conditions. The results of measuring the moisture content (% by mass) of the partial-baked products as well as the oil absorption (g) of the fried bakery products of the present invention and the results for the tasting evaluation are summarized in Table 3.

TABLE 3

| | Day of | | Days of storage | | | | | | | | | |
|---|---|---|---|---|---|---|---|---|---|---|---|---|
| | preparation | | 1 | | 2 | | 3 | | 4 | | 8 | |
| Type of product | A | B | A | B | A | B | A | B | A | B | A | B |
| Mass before frying (g) | — | — | 45 | 53 | 42 | 49 | 43 | 52 | 44 | 52 | 43 | 52 |
| Mass after frying (g) | — | — | 52 | 57 | 47 | 54 | 50 | 57 | 53 | 57 | 53 | 57 |
| Oil absorption (g) | — | — | 7 | 4 | 5 | 5 | 7 | 5 | 10 | 4 | 10 | 5 |
| Tasting evaluation | ⊚ | ⊚ | ⊚ | ⊚ | ⊚ | ⊚ | ⊚ | ⊚ | ⊚ | ⊚ | ⊚ | ⊚ |
| Moisture content of | 22.8 | 27 | 22.6 | — | — | — | — | — | 22.9 | — | 22.8 | — |
| partial-baked | | | | | | | | | | | | |
| products (mass %) | | | | | | | | | | | | |

A: ring doughnut
B: bean jam doughnut
Conditions for partial-baking: 130° C. - 20 minutes
Conditions for storage: stored as refrigerated at 5° C.

The fried bakery products of the present invention of Example 11 were rated ⊚ from the tasting evaluation because the moisture content of the partial-baked products was within an appropriate range (about 22 to 23% by mass for ring doughnuts, and about 27% by mass for bean jam doughnuts), and the oil absorption of the partial-baked products was small and did not change much even after refrigeration. They were palatable fried bakery products which swelled uniformly, had good eating quality and eating texture, and provided healthy feelings.

### EXAMPLE 12

The fried bakery products of the present invention were obtained by preparing fermented molded products (ring doughnuts and bean jam doughnuts) by the same method as in Examples 2 to 10, preparing partial-baked products with no scorched marks on the surfaces by partial-baking the fermented molded products at 130° C. for 20 minutes, and frying the partial-baked products on the very day of preparation at an oil temperature of 185° C. and frying time of 70-70 (seconds) in the reversing mode; at the same time, the fried bakery products of the present invention were obtained by frying the partial-baked products after having stored frozen at −20° C. for 1 to 8 day(s), respectively at an oil temperature of 185° C. and frying time of 70-70 (seconds) in the reversing mode. The bean jam doughnuts were prepared by filling the fermented molded products with about 25 to 30 g of the bean jam filling and then partial-baking under the above-mentioned conditions.

The results of measuring the moisture content (% by mass) of the partial-baked products as well as the oil absorption (g) of the fried bakery products of the present invention and the results for the tasting evaluation are summarized in Table 4.

TABLE 4

| | Day of | | Days of storage | | | | | | | | | |
|---|---|---|---|---|---|---|---|---|---|---|---|---|
| | preparation | | 1 | | 2 | | 3 | | 4 | | 8 | |
| Type of product | A | B | A | B | A | B | A | B | A | B | A | B |
| Mass before frying (g) | — | — | 43 | 54 | 45 | 52 | 44 | 53 | 44 | 51 | 42 | 54 |
| Mass after frying (g) | — | — | 51 | 61 | 55 | 57 | 55 | 58 | 57 | 57 | 53 | 60 |
| Oil absorption (g) | — | — | 8 | 7 | 10 | 5 | 11 | 5 | 13 | 6 | 11 | 6 |
| Tasting evaluation | ⊚ | ⊚ | ⊚ | ⊚ | ⊚ | ⊚ | ⊚ | ⊚ | ⊚ | ⊚ | ⊚ | ⊚ |
| Moisture content of | 22.8 | 27 | 22.6 | — | — | — | — | — | 22.7 | — | 23.3 | — |
| partial-baked | | | | | | | | | | | | |
| products (mass %) | | | | | | | | | | | | |

A: ring doughnut
B: bean jam doughnut
Conditions for partial-baking: 130° C. - 20 minutes
Conditions for storage: stored as frozen at −20° C.

The fried bakery products of the present invention of Example 12 were rated ⊚ from the tasting evaluation because the moisture content of the partial-baked products was within an appropriate range (about 22 to 23% by mass for ring doughnuts, and about 27% by mass for bean jam doughnuts), and the oil absorption of the partial-baked products was small and did not change much even after stored frozen. They were palatable fried bakery products which swelled uniformly, had good eating quality and eating texture, and provided healthy feelings.

### EXAMPLE 13

The fried bakery products of the present invention were obtained by preparing fermented molded products (ring doughnuts and bean jam doughnuts) by the same method as in Examples 2 to 10, preparing partial-baked products with no scorched marks on the surfaces by partial-baking the fermented molded products at 160° C. for 7 minutes, and frying the partial-baked products on the very day of preparation at an oil temperature of 185° C. and frying time of 70-70 (seconds) in the reversing mode; at the same time, the fried bakery products of the present invention were obtained by frying the partial-baked products after having refrigerated at 5° C. for 1 to 8 day(s), respectively at an oil temperature of 185° C. and frying time of 70-70 (seconds) in the reversing mode. The bean jam doughnuts were prepared by filling the fermented molded products with about 25 to 30 g of the bean jam filling and then partial-baking under the above-mentioned conditions.

The results of measuring the moisture content (% by mass) of the partial-baked products as well as the oil absorption (g) of the fried bakery products of the present invention and the results for the tasting evaluation are summarized in Table 5.

TABLE 5

| | Day of | | Days of storage | | | | | | | | | |
|---|---|---|---|---|---|---|---|---|---|---|---|---|
| | preparation | | 1 | | 2 | | 3 | | 4 | | 8 | |
| Type of product | A | B | A | B | A | B | A | B | A | B | A | B |
| Mass before frying (g) | — | — | 44 | 53 | 45 | 51 | 44 | 52 | 43 | 53 | 43 | 52 |
| Mass after frying (g) | — | — | 55 | 57 | 52 | 55 | 53 | 57 | 53 | 58 | 52 | 57 |
| Oil absorption (g) | — | — | 11 | 4 | 7 | 4 | 9 | 5 | 10 | 5 | 9 | 5 |
| Tasting evaluation | ⊚ | ⊚ | ⊚ | ⊚ | ⊚ | ⊚ | ⊚ | ⊚ | ⊚ | ⊚ | ⊚ | ⊚ |
| Moisture content of | 26 | 27.4 | 24.8 | — | — | — | — | — | 25.1 | — | 25.3 | — |
| partial-baked | | | | | | | | | | | | |
| products (mass %) | | | | | | | | | | | | |

A: ring doughnut
B: bean jam doughnut
Conditions for partial-baking: 160° C. - 7 minutes
Conditions for storage: stored as refrigerated at 5° C.

The fried bakery products of the present invention of Example 13 were rated ⊚ from the tasting evaluation because the moisture content of the partial-baked products was within an appropriate range (about 25 to 26% by mass for ring doughnuts, and about 27% by mass for bean jam doughnuts), and the oil absorption of the partial-baked products was small and did not change much even after refrigeration. They were palatable fried bakery products which swelled uniformly, had good eating quality and eating texture, and provided healthy feelings.

### EXAMPLE 14

The fried bakery products of the present invention were obtained by preparing fermented molded products (ring doughnuts and bean jam doughnuts) by the same method as in Examples 2 to 10, preparing partial-baked products with no scorched marks on the surfaces by partial-baking the fermented molded products at 130° C. for 20 minutes, and frying the partial-baked products on the very day of preparation at an oil temperature of 185° C. and frying time of 70-70 (seconds) in the reversing mode; at the same time, the fried bakery products of the present invention were obtained by frying the partial-baked products after having stored frozen at −20° C. for 1 to 8 day(s), respectively at an oil temperature of 185° C. and frying time of 70-70 (seconds) in the reversing mode. The bean jam doughnuts were prepared by filling the fermented molded products with about 25 to 30 g of the bean jam filling and then partial-baking under the above-mentioned conditions.

The results of measuring the moisture content (% by mass) of the partial-baked products as well as the oil absorption (g) of the fried bakery products of the present invention and the results for the tasting evaluation are summarized in Table 6.

TABLE 6

| | Day of | | Days of storage | | | | | | | | | |
|---|---|---|---|---|---|---|---|---|---|---|---|---|
| | preparation | | 1 | | 2 | | 3 | | 4 | | 8 | |
| Type of product | A | B | A | B | A | B | A | B | A | B | A | B |
| Mass before frying (g) | — | — | 44 | 55 | 46 | 54 | 43 | 60 | 46 | 57 | 45 | 53 |
| Mass after frying (g) | — | — | 54 | 62 | 56 | 60 | 55 | 66 | 56 | 63 | 56 | 60 |
| Oil absorption (g) | — | — | 10 | 7 | 10 | 6 | 12 | 6 | 10 | 6 | 11 | 6 |
| Tasting evaluation | ⊚ | ⊚ | ⊚ | ⊚ | ⊚ | ⊚ | ⊚ | ⊚ | ⊚ | ⊚ | ⊚ | ⊚ |
| Moisture content of | 26 | 27.4 | 24.9 | — | — | — | — | — | 24.5 | — | 25.3 | — |
| partial-baked | | | | | | | | | | | | |
| products (mass %) | | | | | | | | | | | | |

A: ring doughnut
B: bean jam doughnut
Conditions for partial-baking: 160° C. - 7 minutes
Conditions for storage: stored as frozen at −20° C.

The fried bakery products of the present invention of Example 14 were rated ⊚ from the tasting evaluation because the moisture content of the partial-baked products was within an appropriate range (about 24 to 26% by mass for ring doughnuts, and about 27% by mass for bean jam doughnuts), and the oil absorption of the partial-baked products was small and did not change much even after stored frozen. They were palatable fried bakery products which swelled uniformly, had good eating quality and eating texture, and provided healthy feelings.

The fried bakery products of the present invention of the Examples are generally voluminous without the lower part being crushed; and swell uniformly and have no blisters on the surfaces; thus, they are in uniform shape.

### COMPARATIVE EXAMPLE 6

Fried bakery products for comparison were obtained by preparing fermented molded products (ring doughnuts and bean jam doughnuts) by the same method as in Examples 11 to 14 except for eliminating the partial-baking step, and frying the fermented molded products at an oil temperature of 185° C. and frying time of 70-70 (seconds) in the reversing mode.

The oil absorption was measured, and the tasting evaluation was also carried out.

| | | | |
|---|---|---|---|
| Ring doughnut | Mass before frying | 49.1 | g |
| | Mass after frying | 64.1 | g |
| | Oil absorption | 15 | g |
| | Tasting evaluation | Δ | |
| Ring doughnut | Mass before frying | 47.6 | g |
| | Mass after frying | 61.9 | g |
| | Oil absorption | 14.3 | g |
| | Tasting evaluation | Δ | |
| Bean jam doughnut | Mass before frying | 55 | g |
| | Mass after frying | 64 | g |
| | Oil absorption | 9 | g |
| | Tasting evaluation | Δ | |

The fried bakery products for comparison of Comparative Example 6 were such that they appeared big but in fact were small in volume after all because of the crushed lower parts, had blisters on the surfaces and were not in uniform shape. They had high oil absorption, and thus they were also evaluated to be greasy and unpalatable with poor eating texture; felt like eating oil with the surface shining with grease; and had a greasy odor and poor eating texture. Moreover, when tasted on the next day of preparation, they underwent aging, showing poor eating quality and eating texture.

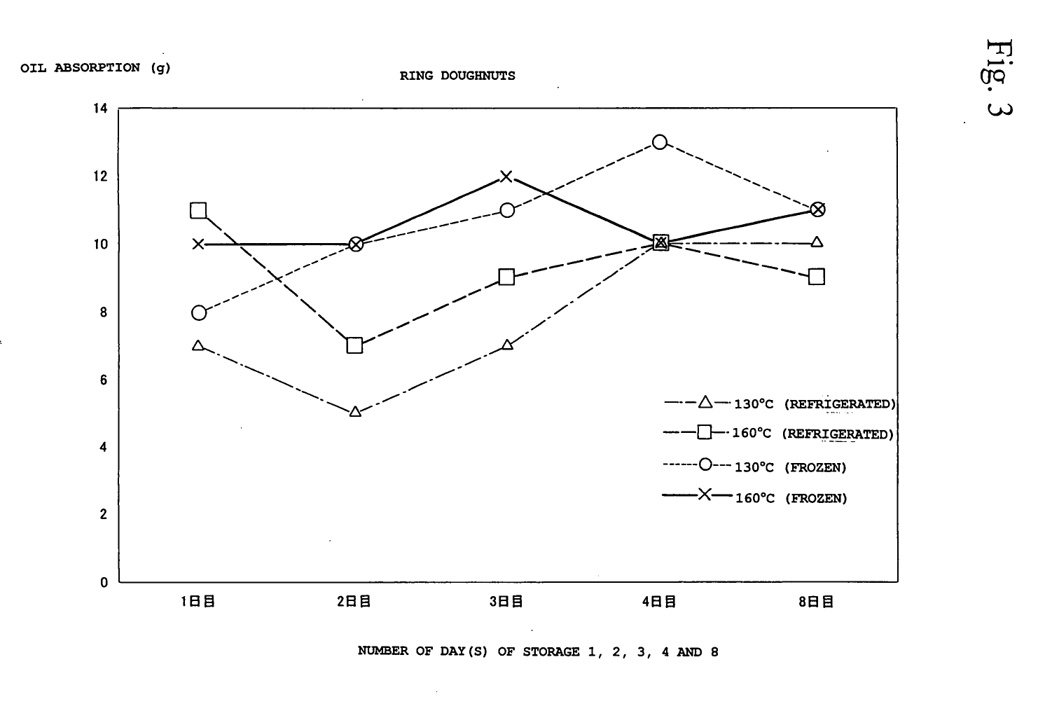

FIG. 3 shows the relationship between the oil absorption (g) and the number of days of storage for ring doughnuts in Examples 11 to 14.

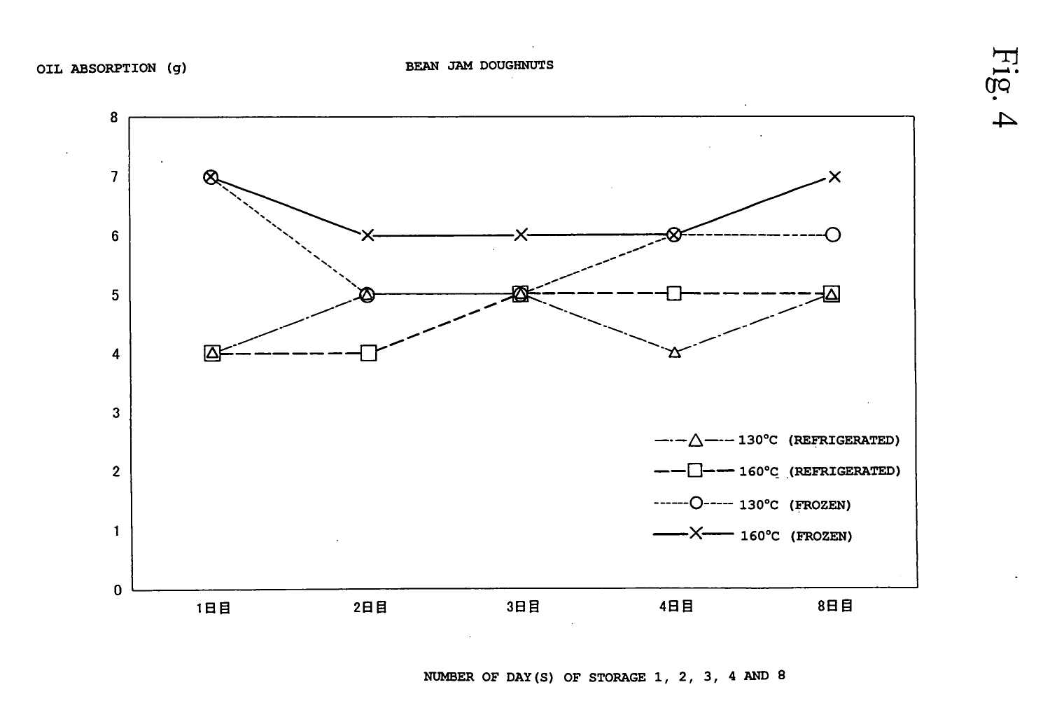

FIG. 4 shows the relationship between the oil absorption (g) and the number of days of storage for bean jam doughnuts in Examples 11 to 14.

The fried bakery products of the present invention are fried bakery products which are obtained by preparing a dough from the starting materials for the dough with mixing and kneading them, subjecting the dough to preliminary fermenting and to dividing and molding, fermenting the molded products, partial-baking the fermented molded products not to be scorched, and frying the partial-baked products in oil, and they are highly valuable in the industrial viewpoint because they have remarkable effects, a lower oil absorption compared with those bakery products obtained by frying the fermented molded products without partial-baking, are not clammy and have adequate crispness; they do not have greasy odors, have good flavor, are not wet, have a good chewy feel and melting feel in the mouth and do not cause heartburn; they are voluminous, soft, have a long best-before period of, for example, about 1 week since they are not susceptible to aging and do not stick to the packaging materials or cause the icing of granulate sugar or chocolate to melt easily; and they uniformly swell and are palatable, providing healthy feelings.

By means of the process for preparing the fried bakery products of the present invention, the fried bakery products of the present invention can be easily prepared without significantly contaminating the frying oil and without significantly decreasing the amount of oil during the frying process.

1. Fried bakery products obtained by preparing a dough by mixing and kneading the starting materials for the dough; subjecting the dough to preliminary fermenting and to dividing and molding, and fermenting the dough to obtain fermented molded products; partial-baking the fermented molded products in order not to be scorched on the surface; and frying the partial-baked products in oil, characterized in that the fried bakery products have a lower oil absorption compared with the fried bakery products obtained by frying the fermented molded products without partial-baking, and that they are not clammy and have adequate crispness.

2. The fried bakery products according to claim 1, characterized in that a natural yeast is used in the fermentation.

3. The fried bakery products according to claim 2, characterized in that they are filled with fillings.

4. A process for preparing fried bakery products, comprising the steps of:
preparing a dough by mixing and kneading the starting materials for the dough;
subjecting thus obtained dough to preliminary fermenting and to dividing and molding, and fermenting the dough to obtain fermented molded products;
partial-baking the fermented molded products to obtain partial-baked products having no scorched marks on the surfaces;
frying the partial-baked products to obtain fried bakery products which have a lower oil absorption compared with the fried bakery products obtained by frying the fermented molded products without partial-baking, which are not clammy and have adequate crispness; and
if desired, filling the fried bakery products with fillings.

5. The process for preparing fried bakery products according to claim 4, characterized in that the fermented molded products are partial-baked at a temperature ranging from 130 to 200° C. for 7 to 25 minutes.

6. The process for preparing fried bakery products according to claim 5, characterized in that when the partial-baked products are fried, the products are fried on one side at 170 to 190° C. for 60 to 150 seconds, and then reversed and fried again on the other side at 170 to 190° C. for 60 to 150 seconds in the reversing mode; and the products are fried as a whole at 170 to 190° C. for 60 to 150 seconds in the submerging mode.
